(19) United States
(12) Patent Application Publication
(10) Pub. No.: US 2024/0399675 A1
(43) Pub. Date: Dec. 5, 2024

(54) IMPROVEMENTS IN OR RELATING TO BEVERAGE CAPSULES

(71) Applicant: Koninklijke Douwe Egberts B.V., Utrecht (NL)

(72) Inventors: Sinem Gkioulen, Utrecht (NL); Geoff York, Banbury (GB); Christopher John Jones, Warwick (GB); Benedict William Flynn Taylor, Warwick (GB); Matthew Edwards, Warwick (GB)

(21) Appl. No.: 18/697,394

(22) PCT Filed: Oct. 3, 2022
(86) PCT No.: PCT/EP2022/077458

§ 371 Date: Mar. 29, 2024

(30) Foreign Application Priority Data
Oct. 4, 2021 (GB) 2114192.4

(51) Int. Cl. B29C 65/00; B29L 31/00; B29L 31/56; B65D 85/804

(52) U.S. Cl. CPC B29C 66/53461; B29C 66/131; B29C 66/24221; B29C 66/73921; B29C 66/849; B65D 85/8043; B29L 2031/565; B29L 2031/7174

(57) ABSTRACT

A beverage capsule (101), a method of lidding a beverage capsule (101) and a sealing head (115) are disclosed. A capsule body and a lid (110) of the beverage capsule (101) together define an internal volume for containing beverage ingredients. A peripheral flange (105) of the capsule body comprises or consists of a thermoplastic polymer, the peripheral flange prior to sealing with the lid having a flat receiving surface (106). The lid (110) also comprises a thermoplastic polymer. The lid (110) is sealed to the peripheral flange (105) to form a first peripheral seal able to withstand pressurisation of the internal volume during use. The first peripheral seal comprises a weld between the thermoplastic polymer of the capsule body and the thermoplastic polymer of the lid (110). A face of the peripheral flange (105) in contact with the lid (110) comprises a recess formed into the flat receiving surface (106) and the lid (110) is sealed to the peripheral flange (105) within the recess.

The present disclosure relates to improvements in or relating to beverage capsules. In particular it relates to a beverage capsule that may be more easily recycled and methods and apparatus for forming such capsules.

### BACKGROUND TO THE DISCLOSURE

In recent years beverage capsules for forming beverages such as coffee, tea and the like have become increasingly popular. Such beverage capsules contain a pre-packaged dose of beverage ingredients that are configured to produce a beverage when dispensed in a compatible beverage preparation machine. Typically, the beverage capsules are each intended to produce a single serving of beverage and are disposed of after a single use, i.e. the beverage capsules are not reusable by the end consumer.

It is a requirement for such beverage capsules that they are able to maintain the freshness of their beverage ingredients during storage of the beverage capsules prior to use. This may be for a period of time of up to a year or more. One option that has been used is to package each individual beverage capsule in an overwrap package that is made of a material that is a moisture and oxygen barrier. However, this solution results in additional packaging waste and inconvenience for the consumer who must open each individual overwrap package prior to use. As a result, overwrap packages are less often used today and instead the composition of the beverage capsules themselves will often now include materials that inhibit or prevent the ingress of moisture and oxygen. For example, beverage capsules may be formed of materials that act themselves as a moisture and or oxygen barrier or may include barrier layers made of such materials.

While these solutions provide improved freshness of the beverage ingredients and increase the shelf life of the beverage capsules they may result in the beverage capsules being composed of multiple different materials that can increase the difficulty in recycling the beverage ingredients after use. For example, where the beverage capsule comprises a capsule body and a lid, the lid may have a different material composition to the capsule body. A particular example of this is that lids of beverage capsules may often comprise or consist of a metal or metallised layer whereas the capsule body may often comprise or consist of a thermoplastic polymer material.

Another requirement of such beverage capsules is that they must often withstand internal pressurisation during use in a beverage preparation machine. It is important therefore that the lid is securely fixed to the capsule body to prevent leaking of the beverage capsule during use, for example by breaching of the seal between the lid and the capsule body. The need to avoid such leaks encourages the adoption of strong seals between the lid and the capsule body. However, this can have the unintended consequence of making recycling of the beverage capsules more difficult because consumers cannot easily after use separate the lid from the capsule body where these are composed of different materials.

Consequently, there is a continuing desire to improve the recyclability of beverage capsules, for example beverage capsules that comprise multiple materials in their composition and in particular where the lid and the capsule body have different material compositions.

### SUMMARY OF THE DISCLOSURE

In a first aspect the present disclosure provides a method of lidding a beverage capsule comprising sealing a lid comprising a thermoplastic polymer to a peripheral flange of a capsule body comprising or consisting of a thermoplastic polymer to form a beverage capsule having an internal volume containing beverage ingredients;
wherein sealing the lid to the peripheral flange comprises:
   forming a first peripheral seal as a weld between the thermoplastic polymer of the peripheral flange and the thermoplastic polymer of the lid by using a sealing head to apply heat and pressure to the peripheral flange and the lid; and simultaneously using the heat and pressure of the sealing head to form a recess in the peripheral flange—optionally an annular recess that extends around the capsule body-such that the lid is sealed to the peripheral flange at least within the recess.

During the lidding process the recess may be formed simultaneously to the creation of the weld between the lid and the peripheral flange. Beneficially, such a process is more tolerant of variations in the alignment of the lid, peripheral flange and sealing head since the recess may be formed at the time of welding, thus ensuring that the lid is welded to the flange within at least the recess. The recess may, for example, be formed by softening and/or melting of the material of the peripheral flange which may then be displaced or flow sideways under the applied pressure of the sealing head to create the recess.

The recess may be formed as a groove in the peripheral flange, the groove comprising an inner land, an outer land and a floor that is located between the inner land and the outer land and that is recessed relative to the inner land and the outer land. Alternatively, the recess may be formed as a rabbet in the peripheral flange, the rabbet comprising an inner land and a floor located outwards of the inner land and that is recessed relative to the inner land.

The recess may be formed to comprise a wall portion leading from the inner land to the floor.

The peripheral flange prior to sealing with the lid may have a flat receiving surface and the recess in the peripheral flange may be formed into the flat receiving surface of the peripheral flange.

The wall portion may be orientated at an angle of 15 to 60 degrees, optionally at 25 to 45 degrees, optionally at 30 degrees to the plane of the inner land.

The sealing head may be heated to a temperature of 200 to 250 degrees Celsius. The temperature may be varied dependent on the available contact time and the material characteristics.

The sealing head may be pressed against the lid and the peripheral flange for 0.3 to 1.5 seconds.

In a second aspect the present disclosure provides a beverage capsule comprising a capsule body and a lid, the capsule body and the lid together defining an internal volume of the beverage capsule for containing beverage ingredients;
the capsule body comprising a peripheral flange that comprises or consists of a thermoplastic polymer;
the lid comprising a thermoplastic polymer;
the lid being sealed to the peripheral flange to form a first peripheral seal able to withstand pressurisation of the internal volume during use, and the first peripheral seal comprises a weld between the thermoplastic polymer of the capsule body and the thermoplastic polymer of the lid;
wherein, after the peripheral flange is sealed to the lid, a face of the peripheral flange in contact with the lid comprises a recess formed into the peripheral flange, wherein optionally the recess is an annular recess that extends around the capsule body, and wherein the lid is sealed to the peripheral flange within the recess.

Advantageously, the recess may be formed simultaneously to the creation of the weld between the lid and the peripheral flange. This permits use of a peripheral flange that is flat prior to the lidding process. This in turn permits easier sealing since there is no requirement for accurate alignment of a sealing head with a pre-formed recess.

The recess may comprise a groove comprising an inner land, an outer land and a floor that is located between the inner land and the outer land and that is recessed relative to the inner land and the outer land. Alternatively, the recess may comprise a rabbet comprising an inner land and a floor located outwards of the inner land and that is recessed relative to the inner land.

The recess may comprise a wall portion leading from the inner land to the floor and the lid may be sealed to at least the wall portion.

The wall portion may be orientated at an angle of 15 to 60 degrees, optionally at 25 to 45 degrees, optionally at 30 degrees, to the plane of the inner land.

The peripheral flange may be generally circular and further comprise a flange tab that extends outwardly to form a graspable protrusion. The lid may be generally disc-shaped and further may comprise a lid tab that extends outwardly to form a graspable protrusion that overlies the flange tab. The flange tab and the lid tab may not be sealed to each other outwardly of the first peripheral seal.

A path of the first peripheral seal may comprise a deviation to promote definition of a peel instigation point of the first peripheral seal. The deviation may be in the region of the lid tab and the flange tab, and optionally may be aligned with a centreline of the lid tab and the flange tab. The deviation may comprise an outward deviation of the first peripheral seal from an otherwise generally circular path. The deviation may comprise a stress focusing point, for example a V-shaped deviation.

The peak peeling force for manually peeling the lid off of the capsule body after use of the beverage capsule may be less than 50N, optionally less than 40N, optionally less than 30N, optionally less than 20N. Optionally, the peak peeling force may be greater than 1 ON, optionally greater than 15N. The peak peeling force may be 10N to 30N, optionally 10N to 20N, optionally 15N to 20N.

The capsule body may further comprise an annular wall located inwards of the peripheral flange that defines a manifold chamber of the beverage capsule and the lid may be sealed to the annular wall to form a second peripheral seal.

The capsule body may further comprise a central tubular wall that defines or contains an outlet of the beverage capsule and the lid may be sealed to the central tubular wall to form a third seal.

An inlet of the beverage capsule may be located towards a periphery of the capsule body.

The capsule body may comprise an integral cup-shaped body comprising wall and base portions defining an open mouth, and the lid may be sealed to the peripheral flange to close off the open mouth.

In a third aspect the present disclosure provides a sealing head for lidding a beverage capsule, the sealing head comprising a peripheral sealing member for sealing a lid comprising a thermoplastic polymer to a peripheral flange of a capsule body comprising or consisting of a thermoplastic polymer to form a beverage capsule having an internal volume containing beverage ingredients;
the peripheral sealing member comprising a sealing surface for forming a first peripheral seal between the lid and the peripheral flange;
the sealing surface comprising a protrusion, optionally an annular protrusion that extends around the peripheral sealing member, for forming a recess in the peripheral flange when the sealing head is heated and pressed against the lid and capsule body in order to form the first peripheral seal by welding the lid to the peripheral flange at least within the recess.

The protrusion may be shaped to form the recess as a groove in the peripheral flange, the groove comprising an inner land, an outer land and a floor that is located between the inner land and the outer land and that is recessed relative to the inner land and the outer land. Alternatively, the protrusion may be shaped to form the recess as a rabbet in the peripheral flange, the rabbet comprising an inner land and a floor located outwards of the inner land and that is recessed relative to the inner land.

The protrusion may be shaped to form a wall portion leading from the inner land to the floor.

The wall portion may be orientated at an angle of 15 to 60 degrees, optionally at 25 to 45 degrees, optionally at 30 degrees to the plane of the inner land.

A path of the protrusion may comprise a deviation to promote definition of a peel instigation point of the first peripheral seal.

The deviation may comprise an outward deviation of the protrusion from an otherwise generally circular path. The deviation may comprise a stress focusing point, for example a V-shaped deviation.

In any of the above aspects, the thermoplastic polymer of the lid and/or the peripheral flange may comprise or consist of one or more homopolymers, copolymers or terpolymers.

Examples of suitable thermoplastic polymers for the lid and/or the peripheral flange include, but are not limited to, polypropylene, polyethylene, polystyrene, polyester, or a mixture or laminate of two or more of these materials. Additionally, the thermoplastic polymer may be a biodegradable and/or compostable polymer.

In any of the above aspects, the thermoplastic polymer of the peripheral flange and the thermoplastic polymer of the lid may be the same.

In any of the above aspects, the lid may comprise an inorganic filler. This may advantageously function to reduce a peak peeling force for breaking the first peripheral seal to manual peel the lid off of the capsule body after use of the beverage capsule. The inorganic filler may comprise or consist of one or more of talc, kaolin, calcium carbonate, or similar materials.

In any of the above aspects, the lid may comprise a laminate comprising at least a sealing layer that contacts the peripheral flange. The sealing layer may comprise or consist of the thermoplastic polymer. An inorganic filler may optionally be included in the sealing layer. The laminate may further comprise one or more structural layers, optionally one or more ductile structural layers. Optionally, one or more of the structural layers may comprise or consist of aluminium or an aluminium alloy.

### BRIEF DESCRIPTION OF THE DRAWINGS

One or more embodiments of the disclosure will now be described, by way of example only, with reference to the accompanying drawings in which:

FIG. 1 is an exterior view of an outer member of a prior art capsule;

FIG. 2 shows an opposite side of the capsule of FIG. 1 with a lid of the capsule removed to show an interior of the prior art capsule;

FIGS. 3 and 4 show a prior art sealing head for heat sealing a lid to the peripheral flange of the capsule of FIG. 1;

FIG. 5 shows a sealing head according to the present disclosure;

FIG. 6 shows the sealing head of FIG. 5 being used to seal a lid to a capsule body of the present disclosure;

FIGS. 7 to 9 show another sealing head according to the present disclosure;

FIGS. 10 to 14 show parts of further sealing heads according to the present disclosure being used to seal a lid to a capsule body;

FIGS. 15 and 16 show schematically cross-sections of the peripheral flange of two capsule bodies according to the present disclosure after sealing, and with the lid removed for clarity;

FIG. 17 shows a sectional view of a distortion of the lid of a prior art capsule in the region of the peripheral flange;

FIG. 18 shows a sectional view of a capsule according to the present disclosure in the region of the peripheral flange;

FIG. 19 shows a sectional view of the lid of the capsule of FIG. 16 in the region of the peripheral flange showing distorted and undistorted configurations of the lid;

FIG. 20 shows schematically a testing apparatus for measuring a peak pealing force of a lid; and

FIG. 21 shows a graph of peak peel force for various capsules.

### DETAILED DESCRIPTION

Unless defined otherwise, all technical and scientific terms used in this specification have the same meaning as is commonly understood by the reader skilled in the art to which the claimed subject matter belongs. It is to be understood that the foregoing summary of the disclosure and the following examples are exemplary and explanatory only and are not restrictive of any subject matter claimed.

The following description is directed to embodiments of the disclosure. The description of the embodiments is not meant to include all the possible embodiments of the disclosure that are claimed in the appended claims. Many modifications, improvements and equivalents which are not explicitly recited in the following embodiments may fall within the scope of the appended claims. Features described as part of one embodiment may be combined with features of one or more other embodiments unless the context clearly requires otherwise.

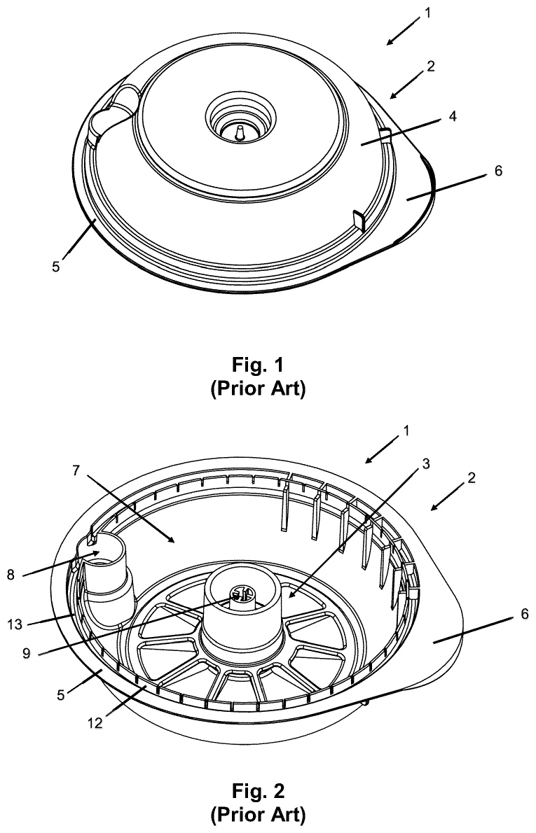

In the following description, by way of example only, the disclosure will be exemplified with reference to a capsule of the general type shown in FIGS. 1 and 2. Such capsules are a type sold under the brand name Tassimo® and are more fully described in GB2397506A, the contents of which are hereby incorporated by reference in their entirety. Each capsule comprises a capsule body and a capsule lid that together define a chamber for holding a beverage ingredient. However, it should be noted that the beverage capsules, sealing heads and methods of the present disclosure are not limited to this type of capsule.

FIG. 1 shows an exterior view of an outer member 2 of a prior art capsule body of a capsule 1. The outer member 2 has a bowl-shaped body 4 and a peripheral flange 5. The peripheral flange 5 is enlarged at one point to form a flange tab 6 that is lobe-shaped. The flange tab 6 may be used to hold and manipulate the capsule 1.

FIG. 2 shows the opposite side of the capsule 1 and the lid is removed to show an interior of the prior art capsule body. An inner member 3 of the capsule body is received in the outer member 2. The chamber 7 above the inner member 3, i.e. between the inner member 3 and the lid, receives a beverage ingredient during filling of the capsule 1. The outer member 2 defines an inlet 8 that is located adjacent the peripheral flange 5. The inner member 3 defines an outlet 9 that is located centrally. Both the inlet 8 and the outlet 9 are covered by the lid and both face in the same direction and are located on the same face of the capsule 1.

The capsule body is formed from polypropylene (PP). The capsule lid is a die-cut lid that is shaped to close the bowl-shaped body 4 of the outer member 2 with a peripheral edge of the capsule lid being sealed, during lidding, to the peripheral flange 5. The capsule lid is formed from a laminate having a layer of aluminium and a layer of polypropylene. The polypropylene layer functions as a heat seal layer that forms a PP-PP welded bond with the peripheral flange 5.

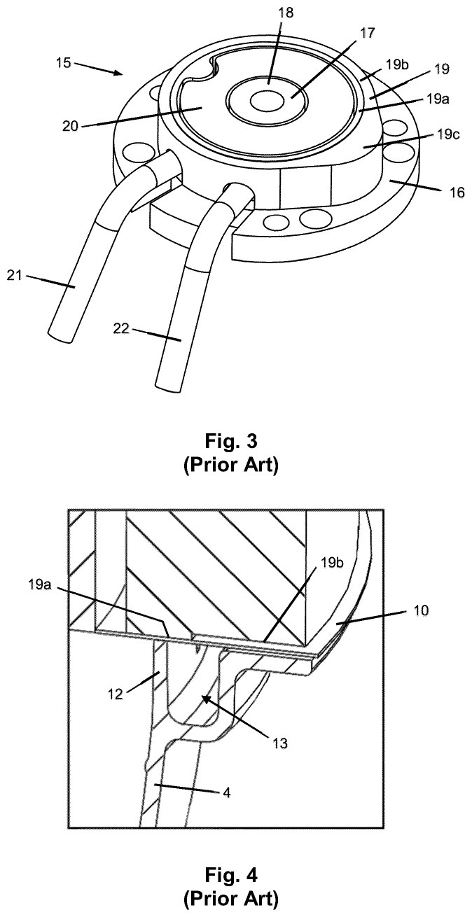

FIGS. 3 and 4 show a prior art sealing head 15 for heat sealing the lid 10 to the peripheral flange 5. The sealing head 15 comprises an outer part 16 and an inner part 17.

The inner part 17 forms a central tower that has a first sealing surface 18 that in use seals the lid to a distal end 11 of the inner member 3 of the capsule body. The first sealing surface 18 is annular and flat.

The outer part 16 is annular and surrounds the inner part 17. The outer part 16 has a second sealing surface 19 that in use seals the lid 10 to the outer member 2 of the capsule body. As shown in FIG. 4, the second sealing surface 19 comprises an inner portion 19a and an outer portion 19b that are at different levels. The inner portion 19a is configured to seal the lid 10 to a distal free edge of an annular wall 12 of the outer member 2 that is inwardly offset from the peripheral flange 5 to define a circumferential manifold 13 of the capsule body. The inner portion 19a is annular and flat. The outer portion 19b is configured to seal the lid 10 to the peripheral flange 5 of the outer member 2. The outer portion 19b is annular and flat. As shown in FIG. 3, the annulus of the outer portion 19b is enlarged at one point to form a lobe-shaped protrusion 19c that matches the shape and size of the flange tab 6 of the outer member 2 and which is configured to seal the lid 10 to the flange tab 6. The outer portion 19b is of a width to seal the lid 10 to the full width, or substantially the full width, of the peripheral flange 5.

The sealing head 15 may further comprise a water cooling jacket 20 that is located between the inner part and the outer part as shown in FIG. 3. In use cooling water may be circulated through the water cooling jacket via an inlet pipe 21 and an outlet pipe 22. The sealing head 15 in use produces a welded seal between the polypropylene of the lid 10 and the polypropylene of the inner member 3 and the outer member 2. The seal is ‘welded’ in that the parts are fused together by an intimate mixing of the material of the lid 10 and the inner member 3 and outer member 2 caused by the application of heat and pressure. This is in contrast to a seal formed by an intervening adhesive layer.

The welded seal is suitable for withstanding internal pressurisation of the capsule 1 during use. However, the welded seal produced by the arrangement of FIGS. 3 and 4 does not lend itself to manual separation of the lid 10 from the capsule body after use to permit recycling because the welded seal is too strong.

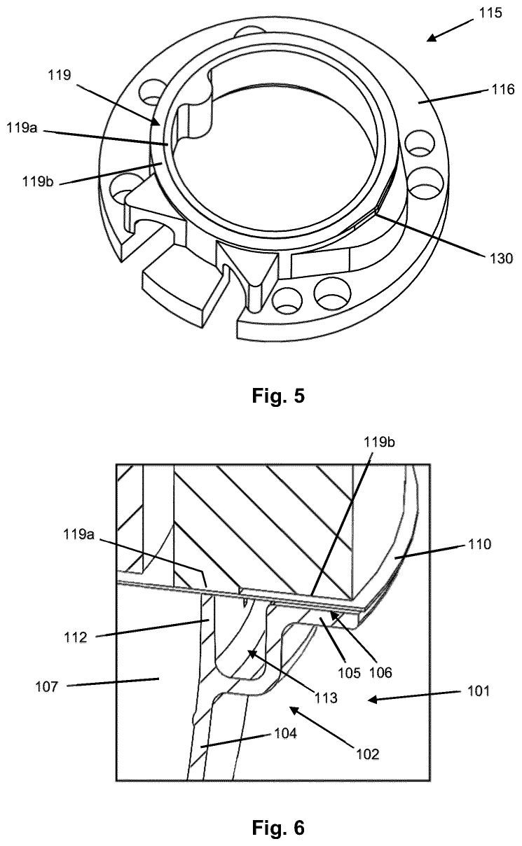

FIGS. 5 and 6 show an embodiment of the present disclosure. In this embodiment the sealing head 115, as shown in FIG. 5, is modified compared to the sealing head 15 of FIG. 3 so as to produce a beverage capsule 101. The beverage capsule 101, as above, comprises an outer member 102 having a lid 110 sealed to a peripheral flange 105 of a bowl-shaped body 104. However, the geometry of the sealing between the lid 110 and the peripheral flange 105 is modified.

The sealing head 115 is configured to seal the lid 110 onto the peripheral flange 105 of the capsule body such that the capsule body and the lid 110 together define an internal volume, e.g. chamber 107, for containing beverage ingredients. The peripheral flange 105 prior to sealing with the lid 110 has a flat receiving surface 106 as shown in FIG. 6. The flat receiving surface 106 may extend across a part or a whole of the width of the peripheral flange 105.

The peripheral flange 105 comprises or consists of a thermoplastic polymer. The lid 110 comprises a thermoplastic polymer. The thermoplastic polymer of the lid 110 and/or the peripheral flange 105 may comprise or consist of one or more homopolymers, copolymers or terpolymers. As non-limiting examples, the thermoplastic polymer of the lid 110 and/or the peripheral flange 105 may be a polypropylene or a polyethylene or a similar thermoplastic. The same thermoplastic polymer may be used in both the peripheral flange 105 and the lid 110.

The sealing head 115 in use seals the lid 110 to the peripheral flange 105 (in particular to the flat receiving surface 106 thereof) to form a first peripheral seal able to withstand pressurisation of the internal volume during use. The first peripheral seal comprises a weld between the thermoplastic polymer of the capsule body and the thermoplastic polymer of the lid 110.

The sealing head 115 may comprise an outer part 116 and an inner part. It should be noted that in FIG. 5 the inner part of the sealing head 115 is omitted for clarity but in use it may be present. For example, the inner part may form a central tower that has a first sealing surface that in use seals the lid 110 to a distal end of the inner member of the capsule body. The first sealing surface may be annular and flat.

The outer part 116 may be annular and may surround the inner part. The outer part 116 may have a second sealing surface 119 that in use seals the lid 110 to the outer member 102 of the capsule body. As most clearly shown in FIG. 6, the second sealing surface 119 may comprise an inner portion 119a and an outer portion 119b that may be at different levels. The inner portion 119a may be configured to seal the lid 110 to a distal free edge of an annular wall 112 of the outer member 102 that is inwardly offset from the peripheral flange 105 to define a circumferential manifold 113 of the capsule body. The inner portion 119a may be annular and flat. The outer portion 119b is configured to seal the lid 110 to the peripheral flange 105 of the outer member 102 to form the first peripheral seal. The outer portion 119b may be annular and flat.

As shown in FIG. 6, the outer portion 119b may be of a width to seal the lid 110 to the full width, or substantially the full width, of the peripheral flange 105. While the sealing head 115 is configured to seal the lid 110 to the peripheral flange 105 of the capsule body it does not comprise a lobe-shaped protrusion that matches the shape and size of the flange tab of the capsule body. Thus, the lid 110 is not sealed to the flange tab of the capsule body during the lidding operation.

The sealing head 115 may also be modified to produce in the beverage capsule, a peel instigation point of the first peripheral seal. The second sealing surface 119, for example the outer portion 119b of the second sealing surface 119, may be shaped to define a peel instigation point of the first peripheral seal. For example, a path of the outer portion 119b of the second sealing surface 119 may comprise a deviation 130 to form the peel instigation point of the first peripheral seal. The deviation 130 may be in the region of the lid tab and the flange tab, and may optionally be aligned with a centreline of the lid tab and the flange tab.

The deviation 130 may comprise an outward deviation of the outer portion 119b of the second sealing surface 119 that forms a matching outward deviation in the first peripheral seal from an otherwise generally circular path. For example, the deviation 130 may comprise a stress focusing point, for example a V-shaped deviation. In the illustrated example of FIG. 5, the deviation 130 in the outer portion 119b may be a shaped increase in the local width of the outer portion 119b that defines a shallow, V-shaped apex that is aligned with the flange tab.

The embodiment of FIGS. 5 and 6 may beneficially be used in combination with a lid 110 that comprises an inorganic filler for reducing a peak peeling force for breaking the first peripheral seal to manual peel the lid 110 off of the capsule body after use of the beverage capsule.

For example, the lid 110 may comprise a laminate comprising at least a sealing layer that contacts the peripheral flange 105, the sealing layer comprising the thermoplastic polymer and the inorganic filler. The laminate may further comprise one or more structural layers, optionally one or more ductile structural layers. Optionally, one or more of the structural layers may comprise or consist of aluminium or an aluminium alloy.

As noted above, the thermoplastic polymer of the peripheral flange 105 and the thermoplastic polymer of the lid 110 may be the same. Examples of suitable thermoplastic polymers include, but are not limited to, polypropylene, polyethylene, polystyrene, polyester, or a mixture or laminate of two or more of these materials.

The inorganic filler may comprise, for example, one or more of talc, kaolin, calcium carbonate, or similar materials.

In use the sealing head 115 may, as shown in FIG. 6, seal the lid 110 to the flange 105 by application of heat and pressure. The lidding process may form a first peripheral seal able to withstand pressurisation of the internal volume during use. The first peripheral seal comprises a weld between the thermoplastic polymer of the capsule body, e.g. of the flange 105, and the thermoplastic polymer of the lid 110.

Due to the absence of any welded connection between the lid tab and the flange tab the lid 110 may be more easily peeled off the capsule body to enable recycling of the capsule after use. Additionally or alternatively, the inclusion of an inorganic filler may reduce the strength of the weld between the lid 110 and the flange 105 allowing the lid 110 to be more easily peeled off the capsule body to enable recycling of the capsule after use. Additionally or alternatively, the provision of the peel instigation point of the first peripheral seal may enable the lid 110 to be more easily peeled off the capsule body.

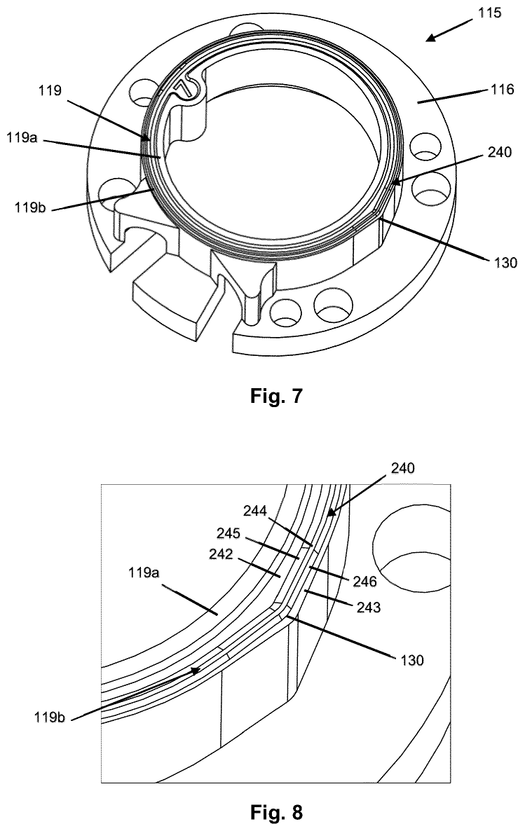

FIGS. 7 to 9 show another embodiment of the present disclosure. In this embodiment the sealing head 115, as shown in FIG. 7, is modified compared to the sealing head 115 of FIG. 5 in that the outer portion 119b of the second sealing surface 119 is not flat but has a convoluted shape. For example, the second sealing surface 119 may comprise a protrusion, optionally an annular protrusion 240 that extends around the second sealing surface 119. The protrusion 240 may be configured to form a recess in the flat receiving surface 106 of the peripheral flange 105 when the sealing head 115 is heated and pressed against the lid 110 and capsule body in order to form the first peripheral seal by welding the lid 110 to the peripheral flange 105 at least within the recess. Advantageously, the recess may be formed in the peripheral flange 105 at the same time as sealing the lid 110 to the recess. Thus, a need for precise alignment of the lid 110 and a pre-formed recess is avoided.

The protrusion 240 may be shaped to form the recess as a groove 141 in the peripheral flange 105 as shown schematically in FIG. 15. The groove 141 may comprise an inner land 142, an outer land 143 and a floor 144 that is located between the inner land 142 and the outer land 143 and that is recessed relative to the inner land 142 and the outer land 143. The groove 141 may comprise an inner wall portion 145 leading from the inner land 142 to the floor 144 and an outer wall portion 146 leading from the outer land 143 to the floor 144.

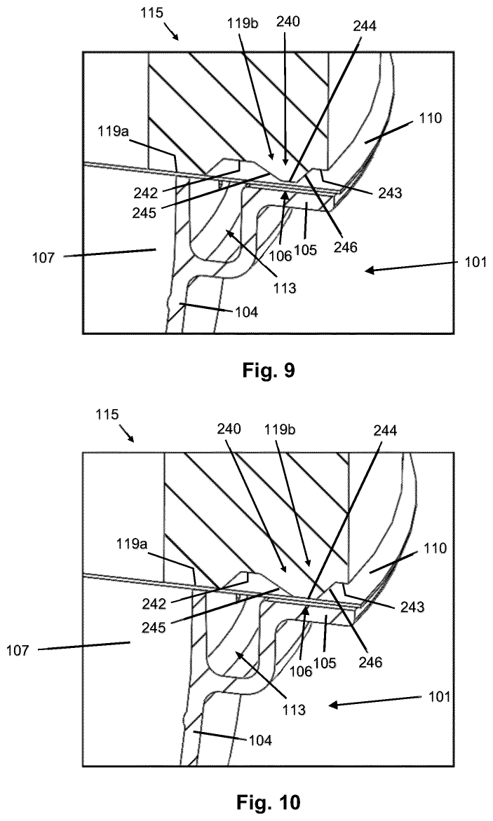

The second sealing surface 119 (including the protrusion 240) may have a complementary shape to the groove 141 so as to form the groove 141 when it is heated and pressed against the thermoplastic polymer material of the flange 105. For example, second sealing surface 119, as shown in FIGS. 8 and 9, may comprise an inner land 242 and an outer land 243 and the protrusion 240 may comprise a peak 244 that may be, for example flat. The protrusion 240 may also comprise an inner wall portion 245 leading from the inner land 242 to the peak 244 and an outer wall portion 246 leading from the outer land 243 to the peak 244.

In the example of FIG. 9, the peak 244 and the inner wall portion 245 and the outer wall portion 246 are flat in cross-section such that the protrusion 240 in cross-section has a trapeziform shape. In addition the inner land 242 and the outer land 243 are flat and horizontal. The peak 244 may be at a different level to the level of the inner portion 119a of the second sealing surface 119. For example, the peak 244 may be raised (in the orientation as shown in FIG. 9) compared to the inner portion 119a.

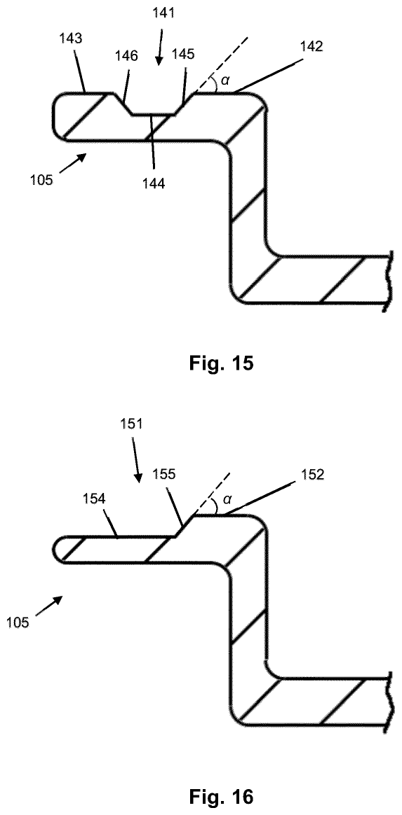

Alternatively, the protrusion 240 may be shaped to form the recess as a rabbet 151 in the peripheral flange 105 as shown schematically in FIG. 16. The rabbet 151 may comprise an inner land 152 and a floor 154 located outwards of the inner land 152 and that is recessed relative to the inner land 152. The rabbet 151 may comprise an inner wall portion 155 leading from the inner land 152 to the floor 154.

The second sealing surface 119 (including the protrusion 240) may have a complementary shape to the rabbet 151 so as to form the rabbet 151 when it is heated and pressed against the thermoplastic polymer material of the flange 105.

In either the groove 141 or the rabbet 151, the inner wall portion 145, 155 may be orientated at an angle, a, of 15 to 60 degrees, optionally at 25 to 45 degrees, optionally at 30 degrees, to the plane of the inner land 142, 152 as shown in FIGS. 15 and 16.

While the sealing head 115 is configured to seal the lid 110 to the peripheral flange 105 of the capsule body it does not comprise a lobe-shaped protrusion that matches the shape and size of the flange tab of the capsule body. Thus, the lid 110 is not sealed to the flange tab of the capsule body during the lidding operation.

In the same way as described above with reference to FIGS. 5 and 6, the sealing head 115 may also comprise a deviation 130 to form a peel instigation point of the first peripheral seal. The deviation 130 may be in the region of the lid tab and the flange tab, and may optionally be aligned with a centreline of the lid tab and the flange tab. As above, the deviation 130 may comprise an outward deviation of the outer portion 119b of the second sealing surface 119 that forms a matching outward deviation in the first peripheral seal from an otherwise generally circular path. For example, the deviation 130 may comprise a stress focusing point, for example a V-shaped deviation. In the illustrated example of FIG. 8, the deviation 130 in the outer portion 119b may include a deviation in the protrusion 240 that defines a shallow, V-shaped apex that is aligned with the flange tab.

The present embodiment may beneficially be used in combination with a lid 110 that comprises an inorganic filler in the same manner as described above.

In use, the sealing head 115 may, as shown in FIG. 9, seal the lid 110 to the flange 105 by application of heat and pressure. The lidding process may form a first peripheral seal able to withstand pressurisation of the internal volume during use. The first peripheral seal comprises a weld between the thermoplastic polymer of the capsule body, e.g. of the peripheral flange 105, and the thermoplastic polymer of the lid 110 at least within the recess. During the lidding process the recess, for example, the groove 141 or rabbet 151, may be formed in the flat receiving surface 106 simultaneously to the creation of the weld between the two parts. In other words, the peripheral flange 105 may be flat prior to the lidding process and the lidding process may form the recess and weld the lid 110 within the recess in the same operation. Thus, a need for precise alignment of the lid 110 and a pre-formed recess is avoided.

As shown in FIG. 9, the protrusion 240 may be positioned to align with a central region of the peripheral flange 105, i.e. away from an inner and an outer edge of the peripheral flange 105.

The sealing head 115 may be heated to a temperature of 200 to 250 degrees Celsius during the lidding process and may be pressed against the lid 110 and the peripheral flange 105 for 0.3 to 1.5 seconds.

Due to the absence of any welded connection between the lid tab and the flange tab the lid 110 may be more easily peeled off the capsule body to enable recycling of the capsule after use. Additionally or alternatively, the inclusion of an inorganic filler may reduce the strength of the weld between the lid 110 and the flange 105 allowing the lid 110 to be more easily peeled off the capsule body to enable recycling of the capsule after use.

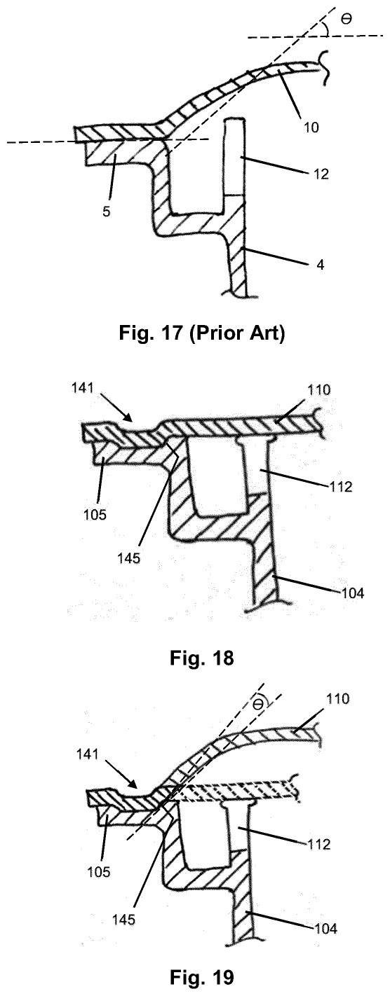

In addition, the presence of the recess may beneficially enable the use of a less strong weld between the lid 110 and the flange 105 while still maintaining safe and acceptable performance of the peripheral seal during internal pressurisation of the capsule as will be described with reference to FIGS. 17 to 19.

FIG. 17 illustrates, schematically, how the lid 10 of the prior art capsule sealed as shown in FIG. 4 may distort during use when it is subjected to internal pressurisation. The internal pressurisation may cause the lid 10 to be distorted upwards (to ‘balloon’). This might, if unchecked, potentially unseal the lid 10 from the distal edge of the annular wall 12 at one or more places since the area of the seal interface on this edge is small. The lid 10 may then balloon upwards due to the internal pressurisation. If this were to occur, the angle of incidence, e, between the angle of the lid 10 and the plane of the flange 5 at the point of contact (at or near an inner edge of the flange 5) would be relatively high. This would have the result that there would be a relatively high resultant force produced by the internal pressurisation tending to want to separate, or peel, the lid 10 from the flange 5. As a consequence of this it has in the past been necessary to increase the strength of the welded seal between the lid 10 and the flange 5 to ensure that bursting of the capsule 1 does not occur.

FIGS. 18 and 19 illustrate how the presence of the recess (in this case the groove 141, but the same applies to the rabbet 151) has the effect of reducing the angle of incidence, e, between the angle of the lid 110 and the plane of the flange 105 at the point of contact of the lid 110 with the inner wall portion 145 of the groove 141. As a result, even if the lid 110 is ballooned upwards by internal pressurisation and separates from the annular wall 112, this will produce a significantly lower resultant force wanting to separate, or peel, the lid 110 from the flange 105. Thus, this improved geometry of the seal enables a less strong welded peripheral seal to be used while maintaining the same performance of the capsules against bursting. In turn, the less strong welded peripheral seal makes it easier for the lid 110 to be peeled off the capsule body by the user after use of the capsule 1.

FIG. 10 shows another embodiment of a sealing head 115 being used to seal the lid 110 to the peripheral flange 105. Only the differences compared to the earlier embodiments will now be described. In other respects the reader is directed to the previous description. Compared to the embodiment of FIG. 9, the protrusion 240 is wider in this embodiment. in particular, the flat peak 244 is wider than the peak 244 of the above embodiment.

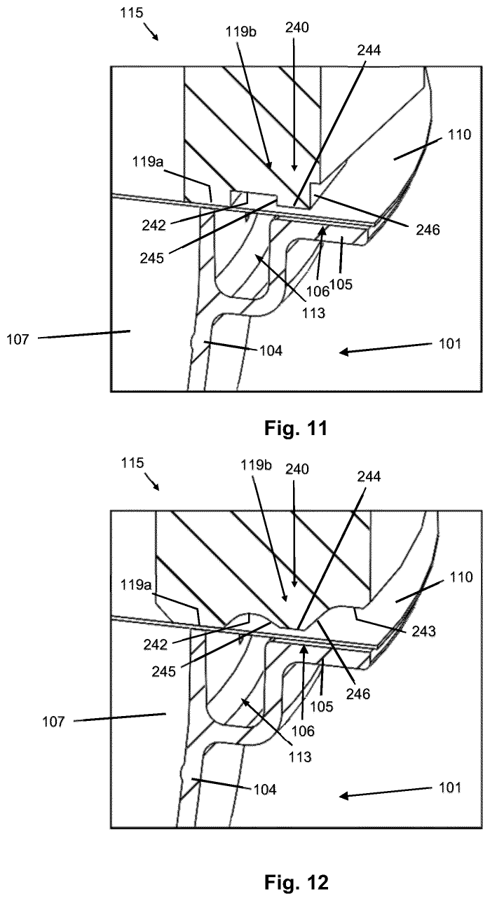

FIG. 11 shows another embodiment of a sealing head 115 being used to seal the lid 110 to the peripheral flange 105. Only the differences compared to the earlier embodiments will now be described. In other respects the reader is directed to the previous description. In this embodiment the outer portion 119b of the second sealing surface 119 comprises a protrusion 240 that comprises a flat peak 244 and vertical inner and outer wall portions 245, 246 such that the protrusion 240 has a rectangular-shaped form. The peak 244 may be at a different level to the level of the inner portion 119a of the second sealing surface 119. For example, the peak 244 may be raised (in the orientation as shown in FIG. 11) compared to the inner portion 119a. The width of the flat peak 244 may be narrow compared to the width of the flange 105. The protrusion 240 may be located such that the flat peak 244 engages on the flat receiving surface 106 of the peripheral flange 105 towards an inner edge of the peripheral flange 105, as shown in FIG. 11. The sealing head 115 of FIG. 11 may be used as described above to form simultaneously a recess in the flange 105 and weld the lid 110 within the recess.

FIG. 12 shows another embodiment of a sealing head 115 being used to seal the lid 110 to the peripheral flange 105. Only the differences compared to the earlier embodiments will now be described. In other respects the reader is directed to the previous description. In this embodiment the outer portion 119b of the second sealing surface 119 comprises a protrusion 240 that is similar to that of FIG. 9. However, in this embodiment the inner wall portion 245 and the outer wall portion 246 are concave-shaped rather than flat and the peak 244 is aligned closer to an inner edge of the flange 105. In addition, a level of the peak 244 is raised slightly compared to the level of the inner portion 119a.

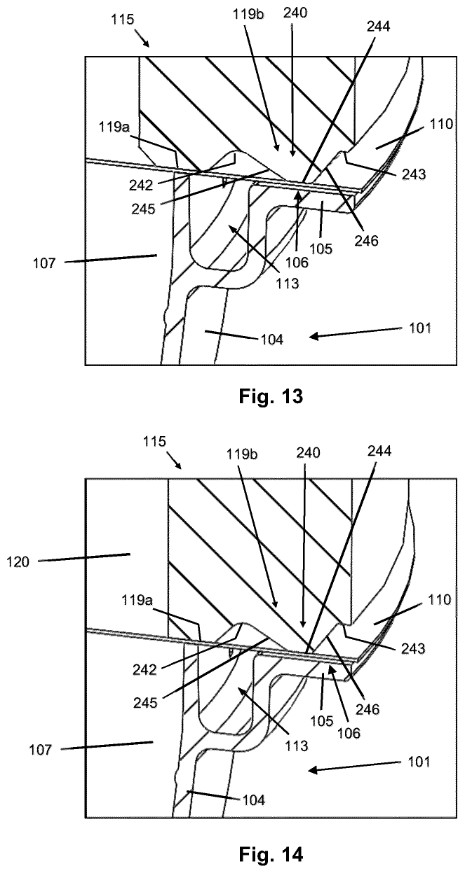

FIG. 13 shows another embodiment of a sealing head 115 being used to seal the lid 110 to the peripheral flange 105. Only the differences compared to the earlier embodiments will now be described. In other respects the reader is directed to the previous description. In this embodiment the outer portion 119b of the second sealing surface 119 comprises a protrusion 240 that is similar to that of FIG. 12. However, in this embodiment the peak 244 is located nearer a middle of the flat receiving surface 106 of the peripheral flange 105 and the level of the peak 244 is at substantially the same level as that of the inner portion 119a.

FIG. 14 shows another embodiment of a sealing head 115 being used to seal the lid 110 to the peripheral flange 105. Only the differences compared to the earlier embodiments will now be described. In other respects the reader is directed to the previous description. This embodiment is the same as that of FIG. 13 except that the sealing head 115 is provided with a water cooling jacket 120.

The capsule 1 of any of the above embodiments may find particular application as a beverage capsule, optionally as a single-serve beverage capsule.

### EXAMPLES

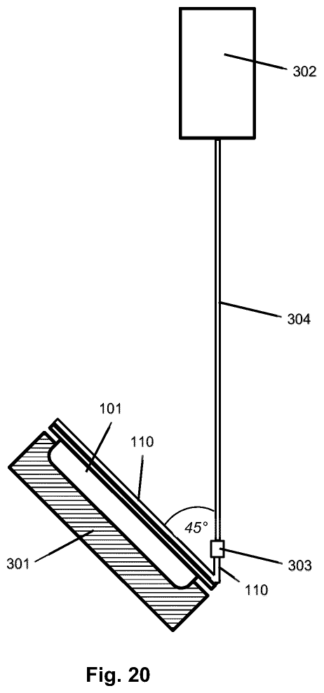

A number of examples beverage capsules 101 were lidded using a sealing head 115 according to the present disclosure. The beverage capsules 101 were then tested to measure the peak pealing force required to remove the lid 110 from the capsule body. To carry out the measurement a testing apparatus as shown in FIG. 20 was used. The testing apparatus comprised a support 301 for holding the beverage capsule 101, a force meter 302 to measure the force applied to the lid 110, a clamp 303 and a cable or chain 304 for coupling the clamp 303 to the force meter 302.

The force meter 302 may be any suitable sensor for measuring the force applied by the clamp 303 to the lid 110. For example the force meter 302 may be a universal testing machine, for example a Tinius Olsen 25ST Electromechanical Materials Testing Machine available from Tinius Olsen of Salfords, United Kingdom. The force meter 302 may comprise or be coupled to a data logger for recording a series of force measurements during de-lidding of the beverage capsule 101.

The clamp 303 was attached to the lobe-shaped protrusion of the lid 110.

The support 301 was configured to hold the beverage capsule 101 such that a plane of the peripheral flange 105 was at 45 degrees to the direction of the force applied by the clamp 303. The lobe-shaped protrusion was pulled back across the body of the beverage capsule 101. The angle and direction of pulling was chosen to mimic the orientation and movement of the lid 110 vis-á-vis the peripheral flange 105 during a manual de-lidding process.

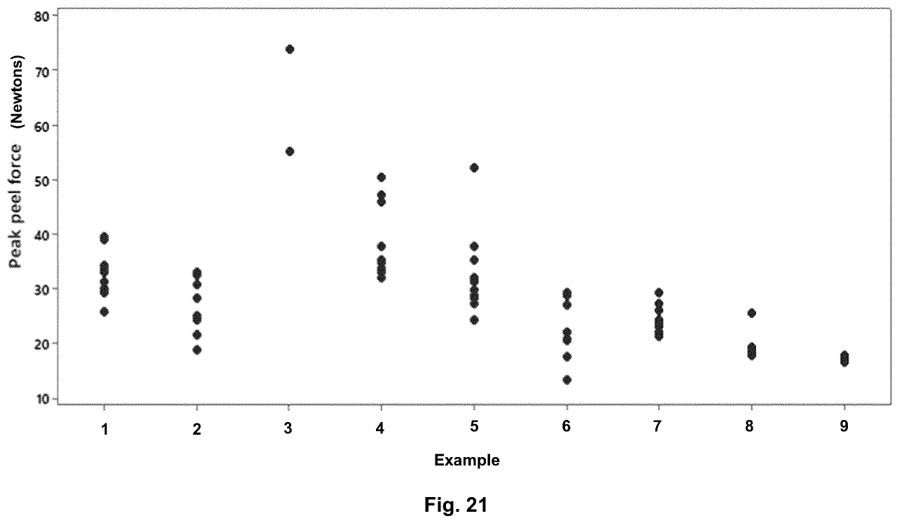

For each example configuration of sealing head 115 and lid 110 multiple tests were carried out. The results are plotted in FIG. 21.

### Examples 1 and 2

The sealing head 115 used for Examples 1 and 2 was that of FIGS. 5 and 6. In both Examples 1 and 2 the lid 110 comprised an inorganic filler. The peak pealing force of Example 1 ranged from 26N to 40N. The peak pealing force of Example 2 ranged from 18N to 34N.

It can be seen that the use of inorganic fillers in the composition of the lid 110 can reduce the peak pealing force. However, the range of peak pealing forces measured is relatively large and many of the results were above 20N which may therefore indicate that the configuration is not entirely optimised for manual de-lidding.

### Example 3

For comparative purposes, Example 3 used the same sealing head as Examples 1 and 2 (that is the sealing head of FIGS. 5 and 6) but used a prior art lid composition that did not include an inorganic filler. The peak pealing force of Example 3 ranged from 65N to 74N.

It can be seen that the range of peak pealing forces measured is very high and certainly unsuitable for manual de-lidding.

### Example 4

Example 4 used the same, prior art, lid composition as that of Example 3 but the sealing head 115 used was that of FIG. 11. The peak pealing force of Example 4 ranged from 33N to 51N.

It can be seen that the use of the sealing head 115 with the protrusion 240 having a rectangular-shaped form significantly reduces the magnitude of the peak pealing forces measured compared to Example 3. However, the range of peak pealing forces is still relatively large and all of the results were above 20N which may therefore indicate that the configuration is not entirely optimised for manual de-lidding.

### Example 5

Example 5 used a lid composition comprising an inorganic filler. The sealing head 115 used was that of FIG. 12. The peak pealing force of Example 5 ranged from 25N to 53N. It can be seen that the use of the sealing head 115 with the protrusion 240 shown in FIG. 12 does show, on average, some reduction in the magnitude of the peak pealing forces measured compared to Example 4. However, the range of peak pealing forces is still relatively large and most of the results were still above 20N which may therefore indicate that the configuration is not entirely optimised for manual de-lidding.

### Example 6

Example 6 used the same lid composition as in Example 5, comprising an inorganic filler. The sealing head 115 used was that of FIG. 13. The peak pealing force of Example 6 ranged from 13N to 28N.

It can be seen that the use of the sealing head 115 with the protrusion 240 shown in FIG. 13 shows a significant reduction in the magnitude of the peak pealing forces measured compared to Example 4. However, the range of peak pealing forces is relatively large and around half of the results were still above 20N which may therefore indicate that the configuration is still not entirely optimised for manual de-lidding.

### Example 7

Example 7 used the same lid composition as in Example 5, comprising an inorganic filler. The sealing head 115 used was that of FIG. 14. The peak pealing force of Example 7 ranged from 22N to 28N.

It can be seen that the use of the sealing head 115 with the protrusion 240 shown in FIG. 14 shows a significant reduction in the magnitude of the peak pealing forces measured compared to Example 4. The range of peak pealing forces is also smaller than in Example 6 showing a better consistency in results. However, all of the results were still above 20N which may therefore indicate that the configuration is still not entirely optimised for manual de-lidding.

### Example 8

Example 8 used the same lid composition as in Example 5, comprising an inorganic filler. The sealing head 115 used was that of FIG. 10. The peak pealing force of Example 8 ranged from 18N to 26N.

It can be seen that the use of the sealing head 115 with the protrusion 240 shown in FIG. 10 shows a significant reduction in the magnitude of the peak pealing forces measured compared to Example 4. The range of peak pealing forces is also smaller than in Example 6 showing a better consistency in results. In addition, most of the results were below 20N which may therefore indicate that the configuration is well optimised for manual de-lidding.

### Example 9

Example 9 used the same lid composition as in Example 5, comprising an inorganic filler. The sealing head 115 used was that of FIGS. 7 to 9. The peak pealing force of Example 9 ranged from 16N to 18N.

It can be seen that the use of the sealing head 115 with the protrusion 240 shown in FIGS. 7 to 9 shows a significant reduction in the magnitude of the peak pealing forces measured compared to Example 4. The range of peak pealing forces is also much smaller than in Examples 6 to 8 showing a very good consistency in results. In addition, all of the results were below 20N which may therefore indicate that the configuration is very well optimised for manual de-lidding.

Further aspects of the present disclosure are set out in the following clauses.

### CLAUSES

Clause A1. A beverage capsule comprising a capsule body and a lid, the capsule body and the lid together defining an internal volume of the beverage capsule for containing beverage ingredients;
the capsule body comprising a peripheral flange that comprises or consists of a thermoplastic polymer, the peripheral flange prior to sealing with the lid having a flat receiving surface;
the lid comprising a thermoplastic polymer;
the lid being sealed to the flat receiving surface of the peripheral flange to form a first peripheral seal able to withstand pressurisation of the internal volume during use, and the first peripheral seal comprises a weld between the thermoplastic polymer of the capsule body and the thermoplastic polymer of the lid;
wherein, after the peripheral flange is sealed to the lid, a face of the peripheral flange in contact with the lid comprises a recess formed into the flat receiving surface of the peripheral flange, wherein optionally the recess is an annular recess that extends around the capsule body, and wherein the lid is sealed to the peripheral flange within the recess.

Clause A2. The beverage capsule of clause A1, wherein the recess comprises a groove comprising an inner land, an outer land and a floor that is located between the inner land and the outer land and that is recessed relative to the inner land and the outer land.

Clause A3. The beverage capsule of clause A2, wherein the recess comprises a rabbet comprising an inner land and a floor located outwards of the inner land and that is recessed relative to the inner land.

Clause A4. The beverage capsule of clause A2 or clause A3, wherein the recess comprises a wall portion leading from the inner land to the floor and the lid is sealed to at least the wall portion.

Clause A5. The beverage capsule of clause A4, wherein the wall portion is orientated at an angle of 15 to 60 degrees, optionally at 25 to 45 degrees, optionally at 30 degrees, to the plane of the inner land.

Clause A6. The beverage capsule of any preceding clause, wherein the peripheral flange is generally circular and further comprises a flange tab that extends outwardly to form a graspable protrusion;
the lid is generally disc-shaped and further comprises a lid tab that extends outwardly to form a graspable protrusion that overlies the flange tab;
wherein the flange tab and the lid tab are not sealed to each other outwardly of the first peripheral seal.

Clause A7. The beverage capsule of any preceding clause, wherein a path of the first peripheral seal comprises a deviation to promote definition of a peel instigation point of the first peripheral seal.

Clause A8. The beverage capsule of clause A7, wherein the deviation is in the region of the lid tab and the flange tab, and optionally is aligned with a centreline of the lid tab and the flange tab.

Clause A9. The beverage capsule of clause A7 or clause A8, wherein the deviation comprises an outward deviation of the first peripheral seal from an otherwise generally circular path.

Clause A10. The beverage capsule of any one of clauses A7 to A9, wherein the deviation comprises a stress focusing point.

Clause A11. The beverage capsule of any preceding clause, wherein the peak peeling force for manually peeling the lid off of the capsule body after use of the beverage capsule is less than 50N, optionally less than 40N, optionally less than 30N, optionally less than 20N.

Clause A12. The beverage capsule of any preceding clause, wherein the capsule body further comprises an annular wall located inwards of the peripheral flange that defines a manifold chamber of the beverage capsule and the lid is sealed to the annular wall to form a second peripheral seal.

Clause A13. The beverage capsule of any preceding clause, wherein the capsule body further comprises a central tubular wall that defines or contains an outlet of the beverage capsule and the lid is sealed to the central tubular wall to form a third seal.

Clause A14. The beverage capsule of any preceding clause, wherein an inlet of the beverage capsule is located towards a periphery of the capsule body.

Clause A15. The beverage capsule of any preceding clause, wherein the capsule body comprises an integral cup-shaped body comprising wall and base portions defining an open mouth, and the lid is sealed to the peripheral flange to close off the open mouth.

Clause B1. A sealing head for lidding a beverage capsule, the sealing head comprising a peripheral sealing member for sealing a lid comprising a thermoplastic polymer to a peripheral flange of a capsule body comprising or consisting of a thermoplastic polymer to form a beverage capsule having an internal volume containing beverage ingredients; the peripheral sealing member comprising a sealing surface for forming a first peripheral seal between the lid and the peripheral flange;
the sealing surface comprising a protrusion, optionally an annular protrusion that extends around the peripheral sealing member, for forming a recess in the peripheral flange when the sealing head is heated and pressed against the lid and capsule body in order to form the first peripheral seal by welding the lid to the peripheral flange at least within the recess.

Clause B2. The sealing head of clause B1, wherein the protrusion is shaped to form the recess as a groove in the peripheral flange, the groove comprising an inner land, an outer land and a floor that is located between the inner land and the outer land and that is recessed relative to the inner land and the outer land.

Clause B3. The sealing head of clause B1, wherein the protrusion is shaped to form the recess as a rabbet in the peripheral flange, the rabbet comprising an inner land and a floor located outwards of the inner land and that is recessed relative to the inner land.

Clause B4. The sealing head of clause B2 or clause B3, wherein the protrusion is shaped to form a wall portion leading from the inner land to the floor.

Clause B5. The sealing head of clause B4, wherein the wall portion is orientated at an angle of 15 to 60 degrees, optionally at 25 to 45 degrees, optionally at 30 degrees, to the plane of the inner land.

Clause B6. The sealing head of any one of clauses B1 to B5, wherein a path of the protrusion comprises a deviation to promote definition of a peel instigation point of the first peripheral seal.

Clause B7. The sealing head of clause B6, wherein the deviation comprises an outward deviation of the protrusion from an otherwise generally circular path.

Clause B8. The sealing head of clause B6 or clause B7, wherein the deviation comprises a stress focusing point.

Clause C1. A method of lidding a beverage capsule comprising sealing a lid comprising a thermoplastic polymer to a peripheral flange of a capsule body comprising or consisting of a thermoplastic polymer to form a beverage capsule having an internal volume containing beverage ingredients;
wherein sealing the lid to the peripheral flange comprises:
   forming a first peripheral seal as a weld between the thermoplastic polymer of the peripheral flange and the thermoplastic polymer of the lid by using a sealing head to apply heat and pressure to the peripheral flange and the lid; and
   simultaneously using the heat and pressure of the sealing head to form a recess in the peripheral flange, optionally an annular recess that extends around the capsule body, such that the lid is sealed to the peripheral flange at least within the recess.

Clause C2. The method of clause C1, wherein the recess is formed as a groove in the peripheral flange, the groove comprising an inner land, an outer land and a floor that is located between the inner land and the outer land and that is recessed relative to the inner land and the outer land.

Clause C3. The method of clause C1, wherein the recess is formed as a rabbet in the peripheral flange, the rabbet comprising an inner land and a floor located outwards of the inner land and that is recessed relative to the inner land.

Clause C4. The method of clause C2 or clause C3, wherein the recess is formed to comprise a wall portion leading from the inner land to the floor.

Clause C5. The method of any one of clauses C1 to C4, wherein the peripheral flange prior to sealing with the lid has a flat receiving surface and the recess in the peripheral flange is formed into the flat receiving surface of the peripheral flange.

Clause C6. The method of clause C4 or C5, wherein the wall portion is orientated at an angle of 15 to 60 degrees, optionally at 25 to 45 degrees, optionally at 30 degrees, to the plane of the inner land.

Clause C7. The method of any one of clauses C1 to C6, wherein the sealing head is heated to a temperature of 200 to 250 degrees Celsius.

Clause C8. The method of any one of clauses C1 to C7, wherein the sealing head is pressed against the lid and the peripheral flange for 0.3 to 1.5 seconds.

Clause D1. A beverage capsule comprising a capsule body and a lid, the capsule body and the lid together defining an internal volume of the beverage capsule for containing beverage ingredients;
the capsule body comprising a peripheral flange that comprises or consists of a thermoplastic polymer;
the lid comprising a thermoplastic polymer;
the lid being sealed to the peripheral flange to form a first peripheral seal able to withstand pressurisation of the internal volume during use, and the first peripheral seal comprises a weld between the thermoplastic polymer of the capsule body and the thermoplastic polymer of the lid;
wherein the lid further comprises an inorganic filler for reducing a peak peeling force for breaking the first peripheral seal to manual peel the lid off of the capsule body after use of the beverage capsule.

Clause D2. The beverage capsule of clause D1, wherein the lid comprises a laminate comprising at least a sealing layer that contacts the peripheral flange, the sealing layer comprising the thermoplastic polymer and the inorganic filler.

Clause D3. The beverage capsule of clause D2, wherein the laminate further comprises a structural layer, optionally a ductile structural layer; and optionally wherein the structural layer comprises aluminium or an aluminium alloy.

Clause D4. The beverage capsule of any one of clauses D1 to D4, wherein the thermoplastic polymer of the peripheral flange and the thermoplastic polymer of the lid are the same.

Clause D5. The beverage capsule of any one of clauses D1 to D4, wherein the inorganic filler comprises or consists of one or more of talc, kaolin, calcium carbonate or similar materials and/or the thermoplastic polymer of the lid and/or the peripheral flange comprises or consists of one or more of a polypropylene or a polyethylene or similar thermoplastics.

Clause D6. The beverage capsule of any one of clauses D1 to D5, wherein the beverage capsule is a beverage capsule according to any one of clauses A1 to A15.

1: A method of lidding a beverage capsule comprising sealing a lid comprising a thermoplastic polymer to a peripheral flange of a capsule body comprising or consisting of a thermoplastic polymer to form a beverage capsule having an internal volume containing beverage ingredients;
wherein sealing the lid to the peripheral flange comprises:
forming a first peripheral seal as a weld between the thermoplastic polymer of the peripheral flange and the thermoplastic polymer of the lid by using a sealing head to apply heat and pressure to the peripheral flange and the lid; and
simultaneously using the heat and pressure of the sealing head to form a recess in the peripheral flange—optionally an annular recess that extends around the capsule body
such that the lid is sealed to the peripheral flange at least within the recess.

2: The method of claim 1, wherein the recess:
is formed as a groove in the peripheral flange, the groove comprising an inner land, an outer land and a floor that is located between the inner land and the outer land and that is recessed relative to the inner land and the outer land; or
the recess is formed as a rabbet in the peripheral flange, the rabbet comprising an inner land and a floor located outwards of the inner land and that is recessed relative to the inner land.

3: The method of claim 2, wherein the recess is formed to comprise a wall portion leading from the inner land to the floor.

4: The method of claim 1, wherein the peripheral flange prior to sealing with the lid has a flat receiving surface and the recess in the peripheral flange is formed into the flat receiving surface of the peripheral flange.

5: The method of claim 1, wherein the sealing head is heated to a temperature of 200 to 250 degrees Celsius.

6: The method of claim 1, wherein the sealing head is pressed against the lid and the peripheral flange for 0.3 to 1.5 seconds.

7: A beverage capsule comprising a capsule body and a lid, the capsule body and the lid together defining an internal volume of the beverage capsule for containing beverage ingredients;
the capsule body comprising a peripheral flange that comprises or consists of a thermoplastic polymer;
the lid comprising a thermoplastic polymer;
the lid being sealed to the peripheral flange to form a first peripheral seal able to withstand pressurisation of the internal volume during use, and the first peripheral seal comprises a weld between the thermoplastic polymer of the capsule body and the thermoplastic polymer of the lid;
wherein, after the peripheral flange is sealed to the lid, a face of the peripheral flange in contact with the lid comprises a recess formed into the peripheral flange, wherein optionally the recess is an annular recess that extends around the capsule body, and wherein the lid is sealed to the peripheral flange within the recess.

8: The beverage capsule of claim 7, wherein:
the recess comprises a groove comprising an inner land, an outer land and a floor that is located between the inner land and the outer land and that is recessed relative to the inner land and the outer land; or
the recess comprises a rabbet comprising an inner land and a floor located outwards of the inner land and that is recessed relative to the inner land,
and optionally wherein the recess comprises a wall portion leading from the inner land to the floor and the lid is sealed to at least the wall portion.

9. (canceled)

10: The beverage capsule of claim 7, wherein the peripheral flange is generally circular and further comprises a flange tab that extends outwardly to form a graspable protrusion;
the lid is generally disc-shaped and further comprises a lid tab that extends outwardly to form a graspable protrusion that overlies the flange tab;
wherein the flange tab and the lid tab are not sealed to each other outwardly of the first peripheral seal.

11: The beverage capsule of claim 7, wherein a path of the first peripheral seal comprises a deviation to promote definition of a peel instigation point of the first peripheral seal
and optionally wherein the deviation is in the region of the lid tab and the flange tab, and optionally is aligned with a centreline of the lid tab and the flange tab.

12. (canceled)

13: The beverage capsule of claim 11, wherein the deviation comprises an outward deviation of the first peripheral seal from an otherwise generally circular path.

14: The beverage capsule of claim 11, wherein the deviation comprises a stress focusing point.

15: The beverage capsule of claim 7, wherein the peak peeling force for manually peeling the lid off of the capsule body after use of the beverage capsule is less than 50N, optionally less than 40N, optionally less than 30N, optionally less than 20N.

16: The beverage capsule of claim 7, wherein the capsule body further comprises an annular wall located inwards of the peripheral flange that defines a manifold chamber of the beverage capsule and the lid is sealed to the annular wall to form a second peripheral seal.

17: The beverage capsule of claim 16, wherein the capsule body further comprises a central tubular wall that defines or contains an outlet of the beverage capsule and the lid is sealed to the central tubular wall to form a third seal.

18: A sealing head for lidding a beverage capsule, the sealing head comprising a peripheral sealing member for sealing a lid comprising a thermoplastic polymer to a peripheral flange of a capsule body comprising or consisting of a thermoplastic polymer to form a beverage capsule having an internal volume containing beverage ingredients;
the peripheral sealing member comprising a sealing surface for forming a first peripheral seal between the lid and the peripheral flange;
the sealing surface comprising a protrusion, optionally an annular protrusion that extends around the peripheral sealing member, for forming a recess in the peripheral flange when the sealing head is heated and pressed against the lid and capsule body in order to form the first peripheral seal by welding the lid to the peripheral flange at least within the recess.

19: The sealing head of claim 18, wherein the protrusion:
is shaped to form the recess as a groove in the peripheral flange, the groove comprising an inner land, an outer land and a floor that is located between the inner land and the outer land and that is recessed relative to the inner land and the outer land; or
is shaped to form the recess as a rabbet in the peripheral flange, the rabbet comprising an inner land and a floor located outwards of the inner land and that is recessed relative to the inner land.

20: The sealing head of claim 19, wherein the protrusion is shaped to form a wall portion leading from the inner land to the floor.

21: The sealing head of claim 18, wherein a path of the protrusion comprises a deviation to promote definition of a peel instigation point of the first peripheral seal,
and optionally wherein the deviation comprises an outward deviation of the protrusion from an otherwise generally circular path;
and optionally wherein the deviation comprises a stress focusing point.

22-23. (canceled)

24: The beverage capsule of claim 7, wherein the capsule body further comprises a central tubular wall that defines or contains an outlet of the beverage capsule and the lid is sealed to the central tubular wall to form a third seal.
